(19) United States
(12) Patent Application Publication
(10) Pub. No.: US 2013/0162092 A1
(43) Pub. Date: Jun. 27, 2013

(54) SINGLE PHASE INDUCTION VIBRATION MOTOR

(71) Applicants: Yong Tae KIM, Suwon (KR); Kyung Su Park, Suwon (KR); Dong Su Moon, Hwaseong (KR)

(72) Inventors: Yong Tae KIM, Suwon (KR); Kyung Su Park, Suwon (KR); Dong Su Moon, Hwaseong (KR)

(73) Assignee: SAMSUNG ELECTRO-MECHANICS CO., LTD.

(21) Appl. No.: 13/416,710

(22) Filed: Mar. 9, 2012

(30) Foreign Application Priority Data
Dec. 26, 2011 (KR) 10-2011-0142691

(51) Int. Cl. H02K 1/00

(52) U.S. Cl. 310/179

(57) ABSTRACT

There is provided a single phase induction vibration motor including: a bottom member including a shaft and a permanent magnet; a rotating member rotatably coupled to the shaft; a coil member disposed on a portion of the rotating member; and a mass member disposed on the coil member such that weight eccentricity of the rotating member with respect to the shaft increases.

### CROSS-REFERENCE TO RELATED APPLICATIONS

This application claims the priority of Korean Patent Application No. 10-2011-0142691 filed on Dec. 26, 2011, in the Korean Intellectual Property Office, the disclosure of which is incorporated herein by reference.

### BACKGROUND OF THE INVENTION

1. Field of the Invention

The present invention relates to a single phase induction vibration motor, and more particularly, to a single phase induction vibration motor having high vibrations and high efficiency.

2. Description of the Related Art

Portable terminals including a mobile phone may include a sound output device (for example, a speaker) and a vibration output device (for example, a vibration motor) as output devices for transferring a user response to an input signal or an external signal.

Among these output devices, the sound output device transfers an output signal through sound to a user, the user may easily recognize the output signal; however, peoples around the user may feel uncomfortable.

On the other hand, since the vibration output device transfers an output signal to the user through tactile sensation, peoples around the user may not feel uncomfortable; however, the vibration output device may be disadvantageous in that user recognition sensitivity is relatively low, current consumption is high, and a volume thereof is significant.

However, as portable terminals including a touch panel have recently been widely spread, the use of the vibration output device has increased.

Therefore, the development of a vibration output device having high vibrations and high efficiency, capable of miniaturizing a portable terminal and ensuring a output signal transfer has been required.

Meanwhile, the vibration output device is disclosed in Patent Documents 1 and 2.

The vibration output device disclosed in Patent Document 1 includes a plurality of coil bundles, such that it is difficult to miniaturize a vibration motor and reduce a weight thereof, and the vibration output device disclosed in Patent Document 2 has a structure in which a magnet 13 is mounted over one surface of a yoke 2, which is a rotating member, such that it is difficult to reduce a weight of the vibration motor.

### RELATED ART DOCUMENT

Patent Document 1 KR2010-97590 A

Patent Document 2 KR2004-110836 A

### SUMMARY OF THE INVENTION

An aspect of the present invention provides a single phase induction vibration motor having a reduced size and improved vibration efficiency.

According to an aspect of the present invention, there is provided a single phase induction vibration motor including: a bottom member including a shaft and a permanent magnet; a rotating member rotatably coupled to the shaft; a coil member disposed on a portion of the rotating member; and a mass member disposed on the coil member such that weight eccentricity of the rotating member with respect to the shaft increases.

The coil member maybe formed of a group of coil bundles.

The mass member may be formed of a non-magnetic material.

The rotating member may include a circuit pattern.

The rotating member may include a magnetic member determining a stationary position of the rotating member.

An angle formed by the magnetic member and the coil member centered on the shaft may be within a range of 150 to 170 degrees.

An angle formed by the magnetic member and the coil member centered on the shaft may be 157.5 degrees.

The elastic member may be a brush supplying current to the coil member.

According to another aspect of the present invention, there is provided a single phase induction vibration motor including: a bottom member having a current supplying circuit formed thereon and a shaft fixed thereto; a rotating member rotatably coupled to the shaft; a mass member disposed on a portion of the rotating member; a coil member disposed on the mass member such that weight eccentricity of the rotating member with respect to the shaft increases; and a cover member coupled to the bottom member and including a permanent magnet.

The coil member maybe formed of a group of coil bundles.

The mass member may be formed of a non-magnetic material.

The rotating member may include a circuit pattern.

The rotating member may include a magnetic member determining a stationary position of the rotating member.

An angle formed by the magnetic member and the coil member centered on the shaft may be within a range of 150 to 170 degrees.

An angle formed by the magnetic member and the coil member centered on the shaft may be 157.5 degrees.

The single phase induction vibration motor may further include an elastic member electrically contacting the rotating member.

The elastic member may be a brush supplying current to the coil member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a single phase induction vibration motor according to an embodiment of the present invention;

FIG. 2 is a perspective view of a rotating member shown in FIG. 1;

FIG. 3 is a plan view describing a positional relationship between a magnetic member and a coil member shown in FIG. 1;

FIG. 4 is a cross-sectional view of a single phase induction vibration motor according to another embodiment of the present invention; and

FIG. 5 is a perspective view of a rotating member shown in FIG. 4.

### DETAILED DESCRIPTION OF THE EMBODIMENTS

According to embodiments of the present invention, a vibration motor having a small size and a light weight may be provided. To this end, the vibration motor according to the embodiments of the present invention may include a single coil member.

The vibration motor having a single coil member may be light as compared to a vibration motor including a plurality of coil members. Further, the single coil member may be widely disposed and accordingly, has a reduced thickness, such that a thickness of the vibration motor may be reduced.

In addition, in the vibration motor according to the embodiments of the present invention, a vibration magnitude may be increased. To this end, a coil member and a weight member may be disposed to overlap each other in the vibration motor.

In the vibration motor having this structure, since a magnitude of weight eccentricity of a rotating member may be increased by the coil member and the weight member, a vibration magnitude according to rotation of the rotating member may be increased.

Therefore, in the vibration motor according to the embodiments of the present invention, a vibration signal may be smoothly transferred to a user.

In addition, the vibration motor according to the embodiments of the present invention may have improved operational reliability. To this end, the vibration motor according to the embodiments of the present invention may further include a magnetic member.

In the vibration motor having this structure, since a stationary position of the rotating member may be determined by the magnetic member, the rotating member may rotate by magnetic force eccentricity all the time.

Hereinafter, embodiments of the present invention will be described in detail with reference to the accompanying drawings.

In describing the present invention below, terms indicating components of the present invention are named in consideration of functions of each component. Therefore, the terms should not be understood as being limited technical components of the present invention.

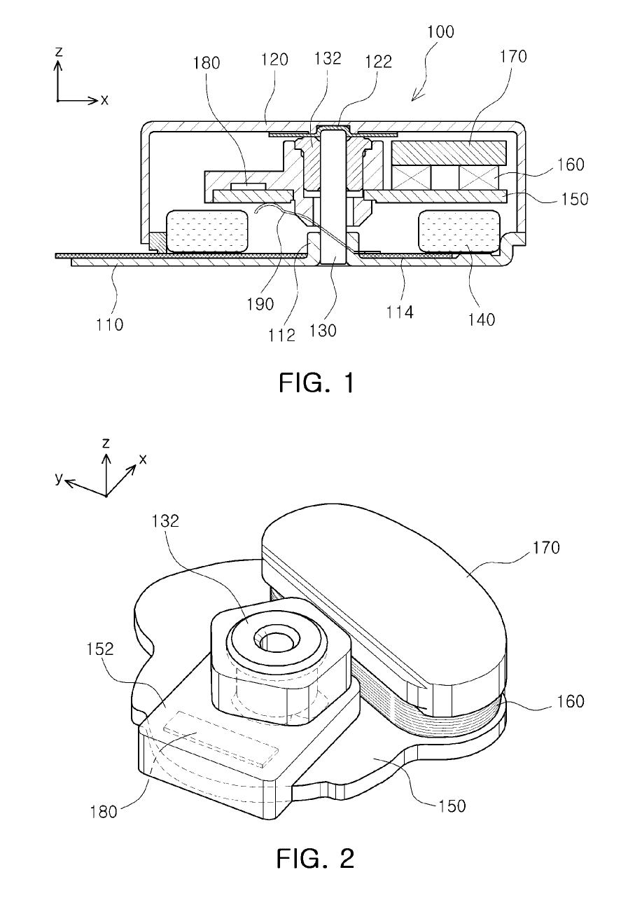

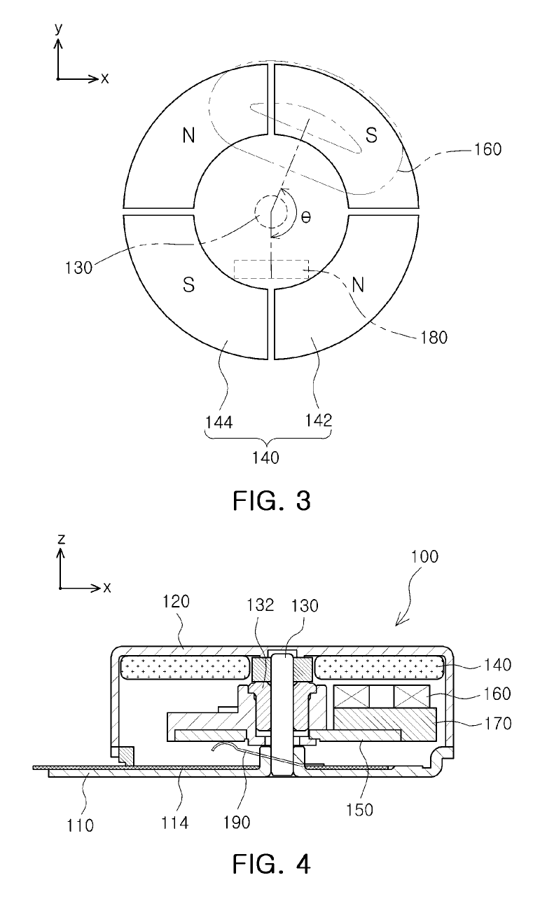

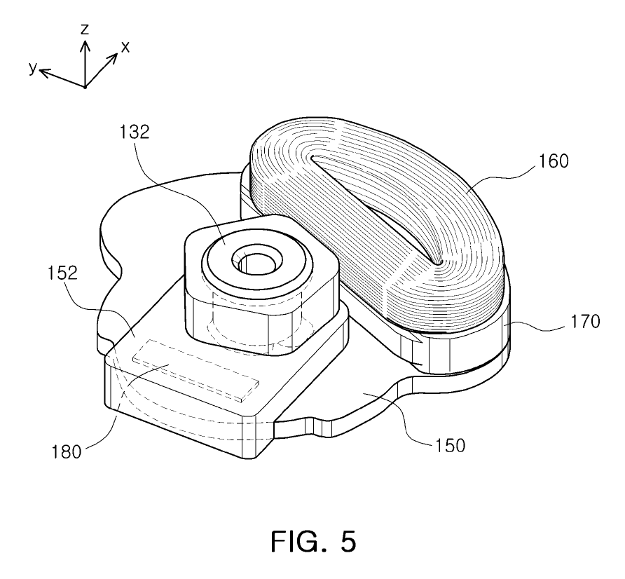

FIG. 1 is a cross-sectional view of a single phase induction vibration motor according to an embodiment of the present invention; FIG. 2 is a perspective view of a rotating member shown in FIG. 1; FIG. 3 is a plan view describing a positional relationship between a magnetic member and a coil member shown in FIG. 1; FIG. 4 is a cross-sectional view of a single phase induction vibration motor according to another embodiment of the present invention; and FIG. 5 is a perspective view of a rotating member shown in FIG. 4.

A single phase induction vibration motor according to an embodiment of the present invention will be described with reference to FIGS. 1 through 3.

A single phase induction vibration motor 100 according to the embodiment of the present invention may include a bottom member 110, a cover member 120, a shaft 130, a permanent magnet 140, a rotating member 150, a coil member 160, and amass member 170. In addition, the single phase induction vibration motor 100 may selectively further include a magnetic member 180 and an elastic member 190.

The bottom member 110 may have a plate shape and be formed of a metal material so as to have a predetermined strength. However, a shape and a material of the bottom member 110 are not limited thereto. Therefore, the bottom member 110 may have a shape corresponding to that of the cover member 120 and be formed of a material other than a metal.

The bottom member 110 may be manufactured by press processing. However, the bottom member 110 maybe manufactured by a mold as necessary.

The bottom member 110 may include a shaft support part 112 coupled to the shaft 130. More specifically, the shaft support part 112 may have a hole into which one end of the shaft 130 is inserted. However, the shape of the shaft support part 112 is not limited thereto, but may also be variously changed as long as it may support the shaft 130.

The bottom member 110 may include a circuit board 114.

The circuit board 114 may include a circuit pattern for supplying current to the coil member 160 and be attached to the bottom member 110. For example, the circuit board 114 may be attached to the bottom member 110 through an adhesive, or the like.

Meanwhile, the bottom member 110 may have a groove having a shape corresponding to that of the circuit board 114 such that the circuit board 114 may be stably fixed to the one surface of the bottom member 110.

Here, the bottom member 110 may be coupled to the circuit board 114 through a bolt, a screw, or the like. Alternatively, the bottom member 110 may be bonded to the circuit board 114 by an adhesive.

The cover member 120 maybe coupled to the bottom member 110. For example, the cover member 120 and the bottom member 110 maybe coupled to each other by welding, caulking, curling, or the like.

The cover member 120 may have a cylindrical shape in which a lower surface thereof is opened and be formed of a metal material having high impact resistance. However, a shape and a material of the cover member 120 are not limited thereto, but may be variously changed. For example, the cover member 120 may have an angular pillar shape and be formed of a material other than a metal.

The cover member 120 may have a groove 122 into which the other end of the shaft 130 is fixed. Here, the groove 122 may have a hole shape in which the other end of the shaft 130 is entirely accommodated or a concave shape in which the other end of the shaft 130 is partially accommodated. An adhesive may be applied to the groove 122 in order to fix the shaft 130 thereto. Meanwhile, in the case in which the shaft 130 may be stably fixed by the shaft support part 112, the groove 122 of the cover member 120 may be omitted.

The shaft 130 may be coupled to the bottom member 110 and may also be selectively coupled to the cover member 120.

The shaft 130 may penetrate through the rotating member 150 and be a rotational center of the rotating member 150. Here, the shaft 130 may include a bearing 132 so as to allow the rotating member 150 to freely rotate. The bearing 132 may be coupled to the shaft 130 or the rotating member 150.

The permanent magnet 140 may be disposed on the bottom member 110. More specifically, the permanent magnet 140 may be disposed in a circular shape centered on the shaft 130.

The permanent magnet 140 may have a plurality of magnets 142 and 144 having different polarities. For example, the permanent magnet 140 may include a plurality of first magnets 142 having a first polarity (an N pole) and a plurality of second magnets 144 having a second polarity (an S pole) as shown in FIG. 3. Here, the number of first magnets 142 is the same as that of second magnets 144.

The first and second magnets 142 and 144 may be alternately disposed centered on the shaft 130. That is, each of the first magnets 142 may be disposed to be adjacent to the second magnets 144, and each of the second magnets 144 may be disposed to be adjacent to the first magnets 142.

The rotating member 150 may be rotatably coupled to the shaft 130. In addition, the rotating member 150 may rotate around the shaft 130. To this end, the rotating member 150 and the shaft 130 may include the bearing 132 disposed therebetween in order to allow for a rotation of the rotating member 150.

The rotating member 150 may be provided with a circuit pattern connected to the coil member 160. Alternatively, the rotating member 150 may be a substrate on which the circuit pattern is formed.

The rotating member 150 may be asymmetrical with respect to the shaft 130. For example, the rotating member 150 may a fan shape or another shape in which it has the center of mass that does not coincide with the center of the shaft 130.

The rotating member 150 may include a fixed member 152, the coil member 160, and the mass member 180.

The fixed member 152 may be formed of a resin material and may be formed integrally with the rotating member 150 while accommodating the bearing 132 therein. For example, the fixed member 152 may be formed on the rotating member 150 having the bearing 132 mounted thereon by an insert injection molding method.

The fixed member 152 may absorb impacts generated during the rotation of the rotating member 150. To this end, the fixed member 152 may be formed of a material capable of easily absorbing impacts. For example, the fixed member 152 may be formed of rubber, a resin, or the like.

The coil member 160 maybe mounted on the rotating member 150 and be connected to a circuit pattern (not shown) formed on the rotating member 150. More specifically, the coil member 160 may be formed on a relatively large portion of the rotating member 150.

The coil member 160 may be formed of a group of coil bundles. The coil member 160 formed of a group of coil bundles may allow for a simplified structure of the single phase induction vibration motor 100 and a reduced weight of the single phase induction vibration motor 100.

The coil member 160 may have an area in which the coil member 160 may interact with at least two magnets 142 and 144 having different polarities when the rotating member 150 is stationary. In the case in which the coil member 160 is formed to correspond to the magnets 142 and 144 having different polarities as described above, the rotating member 150 in a stationary state may smoothly rotate.

That is, in the case in which the coil member 160 has an area in which the coil member 160 may simultaneously face at least two magnets 142 and 144, since repulsive force and attractive force having different magnitudes may simultaneously act on the coil member 160, the rotating member 150 in the stationary state may easily rotate.

The mass member 170 may be formed on the coil member 160. More specifically, the mass member 170 may be formed integrally with the coil member 160 to increase a magnitude of weight eccentricity of the rotating member.

For example, the mass member 170 may be formed of a metal material including tungsten. However, the mass member 170 is not limited to being formed of a metal, but may be formed of a material other than the metal.

The mass member 170 may be coupled to the coil member 160 by an adhesive. For example, the mass member 170 may be coupled to the coil member 160 through an adhesive applied to the coil member 160.

Unlike this, the mass member 170 may be formed integrally with the coil member 160. For example, the mass member 170 may be formed of a coil bundle, similar to the coil member 160. For example, the mass member 170 may be insert injection molded with the coil member 160. In this case, the mass member 170 may be formed of any material as long as it may be insert injection molded.

The magnetic member 180 may be formed on the rotating member 150.

The magnetic member 180 may suppress the rotating member 150 from being biased toward one side by magnetic force of the coil member 160 and the permanent magnet 140. The magnetic member 180 may allow the rotating member 150 to be stopped at a predetermined position.

To this end, the magnetic member 180 may be a magnetic material or a magnet having a polarity. For example, the magnetic member 180 may be a magnet having first and second polarities.

In addition, the magnetic member 180 may be disposed on the rotating member 150 such that it is substantially opposed to the coil member 160. That is, the magnetic member 180 may be disposed such that it is substantially opposed to the coil member 160 centered on the shaft 130, as shown in FIG. 3. More specifically, an angle (θ) formed by the magnetic member 180 and the coil member 160, centered on the shaft 130, may be within a range of 150 to 170 degrees.

For reference, according to the embodiment, the angle (θ) formed by the magnetic member 180 and the coil member 160 centered on the shaft may be 157.5 degrees.

Here, the angle (θ) may be an ideal angle at which the magnetic member 180 or the coil member 160 may be disposed between the magnets 142 and 144 having different polarities.

Attractive force may act between the magnetic member 180, disposed as described above, and the magnets 142 and 144 having different polarities, when the rotating member 150 is stationary, thereby allowing the coil member 160 to be disposed between the magnet 142 having the first polarity and the second magnet 144 having the second polarity. More specifically, the magnetic member 180 may allow the rotating member 150 to be stopped, such that the coil member 160 is disposed to be biased towards the magnet 142 having the first polarity or the second magnet 144 having the second polarity.

The single phase induction vibration motor 100 may further include the elastic member 190.

The elastic member 190 maybe formed on the bottom member 110 and be connected to the rotating member 150. More specifically, the elastic member 190 may electrically connect the circuit board 114 of the bottom member 110 and the circuit pattern of the rotating member 150 to each other.

The elastic member 190 may be a brush alternatively supplying a current in a first direction and a current in a second direction. To this end, the elastic member 190 may be formed of two separated structures.

In addition, the elastic member 190 may support the rotating member 150. To this end, the elastic member 190 may be formed of a metal material having a predetermined elasticity. However, the elastic member 190 is not limited to being formed of the metal material, but may be formed of other materials including a conductive material.

Hereinafter, a single phase induction vibration motor according to another embodiment of the present invention will be described with reference to FIGS. 4 and 5.

The single phase induction vibration motor 100 according to another embodiment of the present invention is different from the single phase induction vibration motor 100, in terms of a disposition structure of the permanent magnet 140, and a disposition structure between the coil member 160, and the mass member 170.

The single phase induction vibration motor 100 according to another embodiment of the present invention may include the bottom member 110, the cover member 120, the shaft 130, the permanent magnet 140, the rotating member 150, the coil member 160, and the mass member 170. In addition, the single phase induction vibration motor 100 may selectively further include the magnetic member 180 and the elastic member 190.

The bottom member 110, the cover member 120, the shaft 130, the rotating member 150, the magnetic member 180, and the elastic member 190 of the single phase induction vibration motor 100 according to another embodiment of the present invention are the same as or are similar to those of the single phase induction vibration motor 100 according to the embodiment of the present invention. Therefore, a detailed description thereof will be omitted.

The permanent magnet 140 may be disposed on the cover member 120. In this structure, since the bottom member 110 may have an increased spare space, the circuit board 114 and the elastic member 190 may be easily disposed on the bottom member 110.

The coil member 160 may be disposed upwardly of the mass member 170. That is, according to the embodiment, the coil member 160 and the mass member 170 may be vertically inverted. The mass member 170 may be formed directly on the rotating member 150.

In this structure, since a distance between the coil member 160 and the permanent magnet 140 decreases, the rotation of the rotating member 150 may be smoothly performed.

Further, in this structure, since the mass member 170 is formed directly on the rotating member 150 which is relatively flat, coupling force between the mass member 170 and the rotating member 150 may be increased. For example, the mass member 170 may be bonded to the rotating member 150 through an adhesive or be coupled to the rotating member 150 through a bolt or a screw.

Therefore, according to the embodiment, a phenomenon in which the mass member 170 is separated from the rotating member 150 due to a high speed rotation of the rotating member 150 may be prevented.

In addition, since the coil member 160 may be attached or coupled to a surface of the mass member 170 which is relatively flat, coupling force between the coil member 160 and the rotating member 150 may also be increased.

As set forth above, according to the embodiments of the present invention, a single phase induction vibration motor having a reduced size and significantly improved vibration efficiency may be provided.

While the present invention has been shown and described in connection with the embodiments, it will be apparent to those skilled in the art that modifications and variations can be made without departing from the spirit and scope of the invention as defined by the appended claims.

What is claimed is:

1. A single phase induction vibration motor comprising:
a bottom member including a shaft and a permanent magnet;
a rotating member rotatably coupled to the shaft;
a coil member disposed on a portion of the rotating member; and
a mass member disposed on the coil member such that weight eccentricity of the rotating member with respect to the shaft increases.

2. The single phase induction vibration motor of claim 1, wherein the coil member is formed of a group of coil bundles.

3. The single phase induction vibration motor of claim 1, wherein the mass member is formed of a non-magnetic material.

4. The single phase induction vibration motor of claim 1, wherein the rotating member includes a circuit pattern.

5. The single phase induction vibration motor of claim 1, wherein the rotating member includes a magnetic member determining a stationary position of the rotating member.

6. The single phase induction vibration motor of claim 5, wherein an angle formed by the magnetic member and the coil member centered on the shaft is within a range of 150 to 170 degrees.

7. The single phase induction vibration motor of claim 5, wherein an angle formed by the magnetic member and the coil member centered on the shaft is 157.5 degrees.

8. The single phase induction vibration motor of claim 1, further comprising an elastic member electrically contacting the rotating member.

9. The single phase induction vibration motor of claim 8, wherein the elastic member is a brush supplying current to the coil member.

10. A single phase induction vibration motor comprising:
a bottom member having a current supplying circuit formed thereon and a shaft fixed thereto;
a rotating member rotatably coupled to the shaft;
amass member disposed on a portion of the rotating member;
a coil member disposed on the mass member such that weight eccentricity of the rotating member with respect to the shaft increases; and
a cover member coupled to the bottom member and including a permanent magnet.

11. The single phase induction vibration motor of claim 10, wherein the coil member is formed of a group of coil bundles.

12. The single phase induction vibration motor of claim 10, wherein the mass member is formed of a non-magnetic material.

13. The single phase induction vibration motor of claim 10, wherein the rotating member includes a circuit pattern.

14. The single phase induction vibration motor of claim 10, wherein the rotating member includes a magnetic member determining a stationary position of the rotating member.

15. The single phase induction vibration motor of claim 14, wherein an angle formed by the magnetic member and the coil member centered on the shaft is within a range of 150 to 170 degrees.

16. The single phase induction vibration motor of claim 14, wherein an angle formed by the magnetic member and the coil member centered on the shaft is 157.5 degrees.

17. The single phase induction vibration motor of claim 10, further comprising an elastic member electrically contacting the rotating member.

18. The single phase induction vibration motor of claim 17, wherein the elastic member is a brush supplying current to the coil member.
